(19) United States
(12) Patent Application Publication
(10) Pub. No.: US 2024/0212401 A1
(43) Pub. Date: Jun. 27, 2024

(54) SYSTEM AND METHOD FOR PROVIDING INTEGRATED SERVICE FOR MOBILE PLATFORM WORKER HISTORY MANAGEMENT

(71) Applicant: INPLAB INC., Gimcheon-si (KR)

(72) Inventors: Won Ho JANG, Gimcheon-si (KR); Yong Min MOON, Gimcheon-si (KR); Sang Deok PARK, Seoul (KR)

(73) Assignee: INPLAB INC., Gimcheon-si (KR)

(21) Appl. No.: 18/394,204

(22) Filed: Dec. 22, 2023

Related U.S. Application Data
(60) Provisional application No. 63/435,015, filed on Dec. 23, 2022.

(30) Foreign Application Priority Data
Dec. 26, 2022 (KR) 10-2022-0183936
Dec. 12, 2023 (KR) 10-2023-0179974

(51) Int. Cl. G07C 5/06; G06Q 40/08

(52) U.S. Cl. CPC G07C 5/06; G06Q 40/08

(57) ABSTRACT

Disclosed is a system for collecting the driving history of a mobile platform worker. The system for collecting the driving history of the mobile platform worker includes a user terminal configured to collect working environment data of a user and communicate with a platform server through a wired or wireless communication network, and the platform server configured to communicate with the user terminal through the wired or wireless communication network and acquire driving history information of the user using the working environment data. According to the present invention, the system for collecting the driving history of the mobile platform worker can improve the rights and interests of the mobile platform worker and provide customized services using vehicle operation data and work data, etc. That is, the system can collect and analyze data related to the user's vehicle operation within a platform server and recommend personalized financial products and customized insurance products based on the analyzed data.

### BACKGROUND

### 1. Field of the Invention

The present invention relates to a system for providing an integrated service for mobile platform worker history management, and more particularly, to a system and method for acquiring driving history information using the working environment data of a mobile platform worker and utilizing the acquired driving history information for various services.

### 2. Discussion of Related Art

Mobile platform workers are workers who obtain jobs such as logistics delivery, food delivery, cleaning, etc., through platform companies that use digital platforms such as apps and SNSs, and work for a certain amount of compensation per job without signing an employment contract. Since most of them are freelancers classified as self-employed, they often lack the legal protections and social benefits for wage workers such as the Labor Standards Act or minimum wage regulations.

In particular, mobile platform workers with unspecified work spaces, such as deliverers, couriers, designated drivers, etc., are exposed to poor working environments. In the middle of summer, they are sweating profusely under the hot sun, and in winter, they are working hard in the bitter cold wind and their hands and feet are freezing.

Social awareness of the need for legal protections for mobile platform workers who suffer from such poor working conditions and heavy workloads is increasing. In this situation, in order to improve the rights and interests of mobile platform workers, there is a need to develop technology for providing customized services (personalized financial products, credit score improvement plans, customized insurance products, etc.) using the vehicle operation data and work data of the platform workers.

In addition, in the case of these mobile platform workers, the driving history is managed separately on multiple platforms, and thus there is a lack of a system for comprehensively managing the labor history of mobile platform workers and protecting and systematically managing the mobile platform workers.

### SUMMARY OF THE INVENTION

The present invention is directed to providing a system for improving the rights and interests of mobile platform workers and providing customized services using vehicle operation data and work data, etc., and a system that collects and analyzes data related to a user's vehicle operation within a platform server and recommends personalized financial products and customized insurance products based on the analyzed data.

According to an aspect of the present invention, there is provided a system for collecting the driving history of a mobile platform worker, which includes a user terminal configured to collect working environment data of a user and communicate with a platform server through a wired or wireless communication network, and the platform server configured to communicate with the user terminal through the wired or wireless communication network and acquire driving history information of the user using the working environment data.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a schematic diagram illustrating a system for providing an integrated service for mobile platform worker history management according to an embodiment of the present invention;

FIG. 2 is a block diagram illustrating a platform server according to an embodiment of the present invention;

FIG. 3 is a block diagram illustrating a system for providing an integrated service for mobile platform worker history management according to an embodiment of the present invention; and

FIG. 4 is a flowchart illustrating a method for providing an integrated service for mobile platform worker history management according to an embodiment of the present invention.

### DETAILED DESCRIPTION OF EXEMPLARY EMBODIMENTS

The advantages and features of the present invention and methods therefor will become apparent with reference to the embodiments described below in detail in conjunction with the accompanying drawings. However, the present invention is not limited to the embodiments disclosed below, and may be implemented in various different forms. The present embodiments are provided only to ensure that the disclosure of the present invention is complete and to completely inform those of ordinary skill in the art of the present invention of the scope of the invention, and the present invention is defined only by the scope of the claims.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined here.

Terminology used herein is for the purpose of describing particular embodiments only and is not intended to limit the invention. As used herein, the singular forms are intended to include the plural forms as well, unless the context clearly indicates otherwise. It should be understood that unless specially stated to the contrary, the terms “comprises” and/or “comprising” used herein specify the presence of stated components, but do not preclude the presence or addition of one or more other components.

Hereinafter, with reference to FIGS. 1 to 4, a system and method for collecting the driving history of a mobile platform worker according to an embodiment of the present invention, and a computing device (or a server, hereinafter referred to as “computing device”) for performing the same will be described. In the drawings, like reference numerals represent like components.

FIG. 1 is a diagram illustrating the configuration of a system 10 for collecting the driving history of a mobile platform worker according to an embodiment of the present invention.

Referring to FIG. 1, the system 10 for collecting the driving history of a mobile platform worker according to the present invention may include a platform server 100 and at least one user terminal 1000-n. If necessary, the system 10 for collecting the driving history of the mobile platform worker may further include an external server 200 and an insurance server 300.

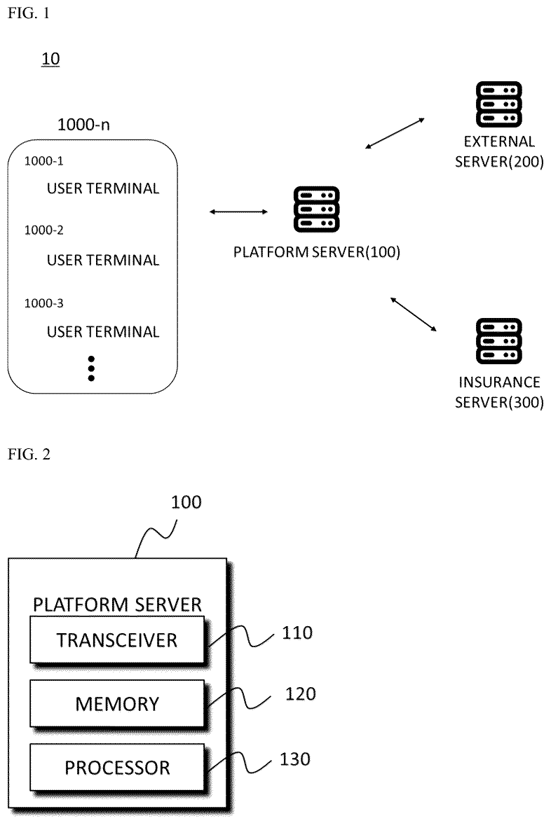

FIG. 2 is a block diagram illustrating a platform server according to an embodiment of the present invention.

Referring to FIG. 2, the platform server 100 is a server for managing the driving history of a mobile platform worker. The platform server 100 is connected to the at least one user terminal 1000-n through a wired or wireless communication network.

The platform server 100 stores various types of information about the mobile platform worker. When a user terminal is connected to the platform server 100, the platform server 100 may acquire various types of information, including working environment data and user health information, from the user terminal. The platform server may acquire at least one of the driving history, driving trajectory, and income information of the user using the working environment data.

The platform server 100 is connected to the external server 200 through a wireless communication network. The platform server 100 may acquire information about a user (worker) from the external server 200. If necessary, the platform server 100 may acquire the health checkup information of the user from the external server 200 and acquire various types of information related to work history such as accident history information, driving aptitude test information, and the like. In addition, the platform server may recommend insurance or financial information to the user using the information acquired from the external server. According to an embodiment, the platform server may recommend an insurance product to the user terminal based on at least one of the driving history, the driving trajectory, the health checkup information, and the driving aptitude test information.

The platform server 100 is connected to the insurance server 300 through a wireless communication network. The platform server 100 may acquire information about the user's (worker's) insurance from the insurance server 300. The information about insurance may be information about subscribed insurance, information about a user's insurance premium rate, or a predefined safe driving index. The safe driving index may be an index related to the driving safety of a driver defined by an insurance company or government agency. If necessary, the safe driving index may be defined by comprehensively analyzing the driver's driving habits such as sudden acceleration and sudden stopping, weather information, road information, and the driver's accident information.

If necessary, when there is a request from the user terminal, the platform server may transmit at least one of the driving history, the driving trajectory, the health checkup information, and the driving aptitude test information to the insurance company's server, and acquire insurance product recommendation data from the insurance company's server and transmit the acquired data to the user terminal.

The user terminal 1000-n is a terminal used by the mobile platform worker and may be provided in various forms such as a general computer, smartphone, tablet PC, or wearable communication type tachograph. That is, the user terminal may include a sensor for acquiring location information, a sensor for acquiring movement or posture information, and a sensor for acquiring an image, and may be any device that can acquire information through sensors and transmit sensing information to the platform server through a network. The user terminal 1000-n may upload various types of sensing information to the platform server in real time through the network. If necessary, the user terminal 1000-n may transmit various request signals to the platform server 100 and receive various types of information through the platform server.

If necessary, the user terminal 1000-n may include an external sensor, and may be connected to at least one device among a full high density (FHD) black box, a high-precision global navigation satellite system (GNSS) sensor, and an inertial navigation system (INS) sensor in a wireless or wired manner to acquire the sensing data from the device. The user terminal may upload data acquired from the external sensor to the platform server.

The FHD black box is a device for capturing videos while the user is driving, and may acquire event videos such as front videos, sudden stops, sudden starts, accidents, etc., and transmit the acquired videos to the user terminal. The high-precision GNSS sensor is a device for acquiring location information including the user's latitude, longitude, and altitude information, and the INS sensor is a device for acquiring posture information including the movement of vehicles and users.

The user terminal and the sensors included in the user terminal may be easily detached from a harness and simply fixed on a rear-view mirror or dashboard when the user drives the vehicle. Through this, work data or driving data may be acquired reliably during driving the vehicle.

If necessary, the system 10 for collecting the driving history of the mobile platform worker may further include a power supply unit 2000, a control unit 3000, a harness 4000, and an emergency signal unit.

The power supply unit 2000 is a component for supplying power to the user terminal. The user terminal may include a component for supplying power to the user terminal itself, and include an additional external power supply unit as needed. In addition, the power supply unit 2000 may supply power to the various sensors included in the user terminal.

The control unit 3000 is a component for controlling the user terminal and the power supply unit. When starting commercial transport, the user may start the system through the control unit 3000, and the user terminal may upload working environment data generated during commercial transport to the platform server in real time. The user may control the control unit to end the uploading of the working environment data when commercial transport ends.

The emergency signal unit is a component for quickly transmitting a signal to the external server or platform server when the user encounters an emergency situation. In other words, in the case of mobile platform workers, they face various dangerous situations in the working environment, and when an emergency signal occurs, the danger may be quickly notified to the outside through the emergency signal unit.

If necessary, the emergency signal unit may transmit a danger signal to the outside using a physical signal, and transmit the danger signal to the outside based on the signal acquired from the user terminal. That is, according to an embodiment, the emergency signal unit may transmit the danger signal to the outside based on movement speed information acquired from the user terminal. The emergency signal unit may transmit the danger signal to the platform server when the movement speed information acquired from the user terminal is greater than and equal to a predetermined standard or when there is no movement for more than a certain period of time after a sudden stop.

According to a specific embodiment of the present invention, the control unit 3000 may be provided as a single button, and when the user presses the control unit for a certain period of time, the user terminal may start uploading to the platform server, and when pressing the control unit again, the uploading may be terminated. In addition, when the user presses the button for more than a certain period of time, the danger signal unit may transmit the danger signal to the outside.

The harness 4000 is a device that allows the user to easily wear various components of the system and move, and may be designed to be worn by the user. The user terminal and the power supply unit are detachably fastened to the harness 4000. If necessary, the harness 400 may include a fastening portion for fixing the user terminal or the power supply unit. One or more fastening portions may be provided, and the user terminal, the various sensors included in the user terminal, and the power supply may be attached and detached with one touch.

The platform server 100 was designed to more effectively and systematically manage the scattered driving history information of the mobile platform worker. That is, the platform server 100 of the system for collecting the labor history may acquire various types of information including working environment data and user health information from the user terminal, and use the acquired information to acquire at least one of the driving history, driving trajectory, and commercial transport income information of the user, and using this, customized insurance premium rates are calculated, a safe driving index is calculated, or inexpensive insurance products based on data are recommended. The safe driving index is an index that can be calculated based on driving distance information, accident history information, customer satisfaction information, etc., and can be defined in various ways using various types of information related to driving. In other words, the system for collecting the driving history may provide various services to the user by utilizing the user's driving history information.

The working environment data is data generated when a mobile platform worker, that is, a user works or engages in commercial transport, and refers to at least one of the user's location information, movement information of vehicles and users, and video information captured during transport.

The user's driving history may include not only information such as the starting and ending points of the user's commercial transport, driving distance information, driving area information, etc., but also various types of driving information generated during commercial transport, such as sudden stop and sudden acceleration history, driving pattern information, work efficiency information, and the like.

The driving trajectory information refers to the user's driving trajectory information during commercial transport, and through this, the safety of the user's driving may be determined.

In other words, the platform server acquires the working environment data from the user terminal and uses the acquire data to acquire information such as the user's driving history, driving trajectory, and commercial transport income information. In addition, the platform server may use the acquired information to provide the user with information such as financial information, insurance information, a method for improving work efficiency, and the like.

The platform server may acquire various types of information and convert the acquired information into a database. According to an embodiment, the platform server may acquire various types of information that can affect the driving history or insurance premium rate calculation, including the user's personal information, driving aptitude test information, driving history information, driving revenue information, driving trajectory information, and health checkup information and convert the acquired information into a database.

If necessary, the platform server 100 may collect various types of information related to the user's driving ability from an external server. According to an embodiment, the platform server 100 may acquire the driving aptitude test information of the user from the external server, and acquire the user's personal information and health checkup information.

If necessary, the platform server 100 may acquire history information about the user's insurance from the insurance server. In addition, the platform server 100 may transmit at least one of the user's working environment data, health information, driving history, driving trajectory, and income information to the insurance server in response to a request of the user, and the insurance server may recommend insurance products based on the acquired data or transmit modified insurance premium rate information to the system.

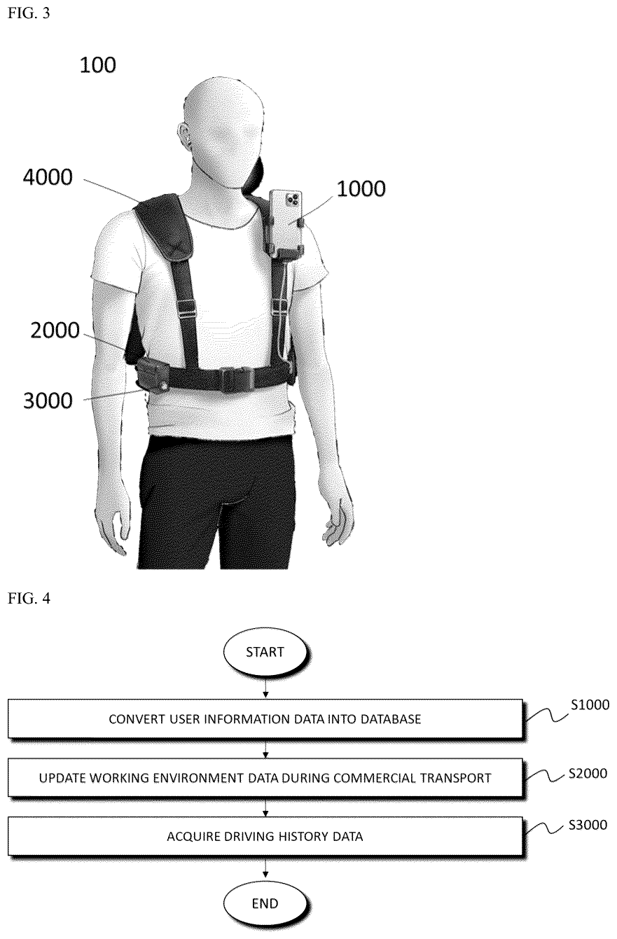

Hereinafter, with reference to FIG. 4, the operations of a method for collecting labor history according to an embodiment of the present invention will be described in detail.

Referring to FIG. 4, the method of collecting the driving history of mobile platform worker may include receiving user information and converting the received information into a database (S1000), receiving and updating the information (S2000), and acquiring driving history information (S3000).

A server may receive user information from at least one user terminal and convert the received user information into a database. The user information refers to information for identifying the user, such as the user's age, gender, and driving experience.

When the user engages in commercial transport, the server may receive and update at least one of the user's location information, movement information of vehicles and users, and video information captured during transport.

The server may acquire driving history information that includes at least one of the user's driving history, driving trajectory information, and income information based on the updated information.

If necessary, the method for collecting the driving history of the worker may further include recommending an insurance product to the user terminal based on the driving history and driving trajectory information.

If necessary, the method for collecting the driving history of the worker may further include acquiring health checkup information and driving aptitude test information of the user from the external server, transmitting the driving history, driving trajectory information, health checkup information, and driving aptitude test information to an insurance company server in response to a request from the user terminal, and acquiring insurance product recommendation data from the insurance company server.

According to the present invention, the system for collecting the driving history of the mobile platform worker can improve the rights and interests of the mobile platform worker and provide customized services using vehicle operation data and work data, etc. That is, the system may collect and analyze data related to the user's vehicle operation within a platform server and recommend personalized financial products and customized insurance products based on the analyzed data.

Features, structures, effects, etc. described in the above embodiments are included in at least one embodiment of the invention, and are not necessarily limited to only one embodiment. Furthermore, features, structures, effects, etc. illustrated in each embodiment may be combined or modified for other embodiments by those of ordinary skill in the art to which the embodiments belong. Accordingly, the content related to such combinations and modifications should be interpreted as being included in the scope of the invention.

In addition, although the embodiment has been described above, it is only an example and does not limit the present invention, and those of ordinary skill in the art to which the present invention pertains will recognize that various modifications and applications not exemplified above without departing from the essential characteristics of the present embodiment. In other words, each component specifically shown in the embodiment may be modified and implemented. Also, the differences related to these modifications and applications should be construed as being included in the scope of the present invention defined in the appended claims.

What is claimed is:

1. A system for collecting the driving history of a mobile platform worker, the system comprising:
a user terminal configured to collect working environment data of a user and communicate with a platform server through a wired or wireless communication network; and
the platform server configured to communicate with the user terminal through the wired or wireless communication network and acquire driving history information of the user using the working environment data.

2. The system of claim 1, further comprising:
a power supply unit configured to supply power to the user terminal;
a control unit configured to control an operation of the user terminal and the power supply unit; and
a harness to which the user terminal and the power supply are detachably fastened and configured to be worn by the user.

3. The system of claim 1, further comprising an emergency signal unit configured to transmit a signal to an external device when an emergency situation occurs,
wherein the working environment data is data generated during commercial transport and includes at least one of location information of the user, movement information of vehicles and users, and video information captured during transport.

4. The system of claim 2, wherein the harness includes a fastening portion configured to fix the user terminal, and the control unit controls the user terminal to upload the working environment data to the server when commercial transport begins and controls the user terminal to end uploading of the working environment data when commercial transport ends.

5. The system of claim 1, wherein the server acquires health checkup information and driving aptitude test information of the user from an external server, and acquires at least one of the driving history, driving trajectory, and income information of the user using the working environment data.

6. The system of claim 5, wherein the server recommends an insurance product to the user terminal based on at least one of the driving history, the driving trajectory, the health checkup information, and the driving aptitude test information.

7. The system of claim 5, wherein, when there is a request from the user terminal, the server transmits at least one of the driving history, the driving trajectory, the health checkup information, and the driving aptitude test information to an insurance company server, acquires insurance product recommendation data from the insurance company server, and transmits the acquired insurance product recommendation data to the user terminal.

8. A method of collecting the driving history of a mobile platform worker, the method comprising:
receiving user information from at least one user terminal and converting the received user information into a database;
receiving and updating, during commercial transport, at least one of location information of the user, movement information of vehicles and users, and video information captured during transport; and
acquiring at least one of driving history information, driving trajectory information, and income information of the user based on the updated information.

9. The method of claim 8, further comprising recommending, by the server, an insurance product to the user terminal based on the driving history and driving trajectory.

10. The method of claim 8, further comprising:
acquiring, by the server, health checkup information and driving aptitude test information from an external server;
transmitting the driving history, the driving trajectory, the health checkup information, and the driving aptitude test information to an insurance company server in response to a request from the user; and
acquiring insurance product recommendation data from the insurance company server.
